(19) United States
(12) Patent Application Publication
(10) Pub. No.: US 2010/0165627 A1
(43) Pub. Date: Jul. 1, 2010

(54) LIGHT EMITTING MODULE AND LED LAMP EMPLOYING IT

(75) Inventors: SHIH-HSUN WUNG, Tu-Cheng (TW); YONG-DONG CHEN, Shenzhen City (CN); WEN XU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: Fu Zhun Precision Industry (Shen Zhen) Co., Ltd., Shenzhen City (CN); Foxconn Technology Co., Ltd., Tu-Cheng (TW)

(21) Appl. No.: 12/492,138

(22) Filed: Jun. 26, 2009

(30) Foreign Application Priority Data
Dec. 27, 2008 (CN) 200810306569.5

(51) Int. Cl. F21V 21/00; F21V 29/00

(52) U.S. Cl. 362/249.02; 362/294

(57) ABSTRACT

An LED lamp comprises an array of light emitting modules. The light emitting modules each comprise a grille, a heat sink, an LED module and a transparent plate. The grille comprises an inner wall and a frame extending integrally upwards and downwards from the inner wall. The heat sink has a bottom portion thereof extending through the inner wall and has two opposite ends of a top portion thereof abutting the inner wall. The LED module is attached to a top side of the heat sink. The transparent plate is mounted on a top end of the grille and covers the heat sink and the LED module. A plurality of fasteners extend through the inner wall, each having a rotatable resisting portion. The resisting portion presses the heat sink downwardly on the inner wall.

### BACKGROUND

1. Technical Field

The disclosure relates to an illuminating device and, more particularly, to a light emitting module and an LED (light emitting diode) lamp using the light emitting module.

2. Description of Related Art

An LED lamp utilizing LEDs as a source of illumination is widely used in many fields because the LEDs have features of long-term reliability, environment friendliness and low power consumption. It is well-known that a conventional grille lamp utilizes fluorescent lights as a source of illumination. With the development of the LED lamp, the LED lamp is intended to be a cost-effective yet high quality replacement for the conventional grille lamp.

Generally, the LED lamp comprises a bracket integrally formed via a die and a plurality of LED modules received in the bracket. The LED lamp can achieve a certain illumination intensity because a dimension of the bracket is certain. For achieving different illumination intensities according to actual needs, the dimension of the bracket has to be changed. However, a change of the die of the bracket raises a considerable cost burden.

What is needed, therefore, is a light emitting module and an LED lamp employing the light emitting module for meeting different illumination demands.

### BRIEF DESCRIPTION OF THE DRAWINGS

Many aspects of the present LED lamp can be better understood with reference to the following drawings. The components in the drawings are not necessarily drawn to scale, the emphasis instead being placed upon clearly illustrating the principles of the present LED lamp. Moreover, in the drawings, like reference numerals designate corresponding parts throughout the several views.

FIG. 1 is an isometric, assembled view of a light emitting module in accordance with an embodiment of the disclosure.

FIG. 2 is an isometric, exploded view of the light emitting module of FIG. 1.

FIG. 3 is an inverted view of FIG. 2.

FIG. 4 is an isometric, enlarged view of a fastener of the light emitting module of FIG. 3.

FIG. 5 is a front view of an LED lamp employing the light emitting module of FIG. 1.

FIG. 6 is a front view of an alternative LED lamp employing the light emitting module of FIG. 1.

### DETAILED DESCRIPTION

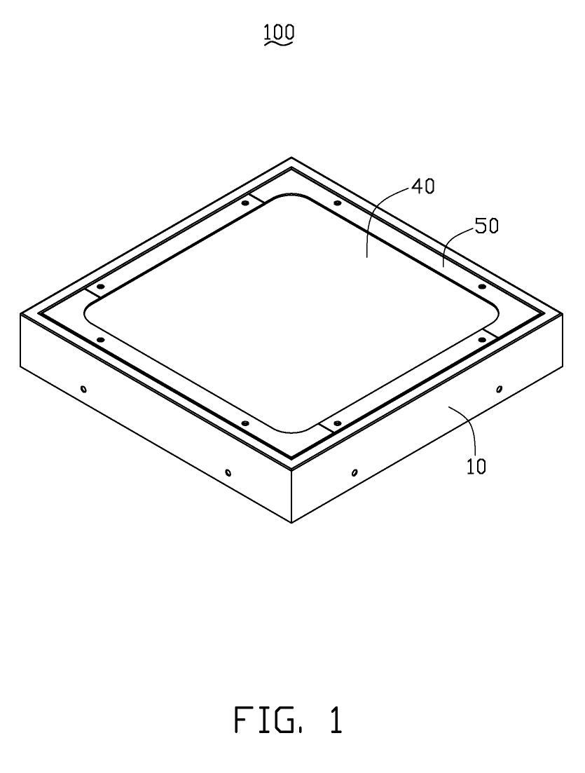

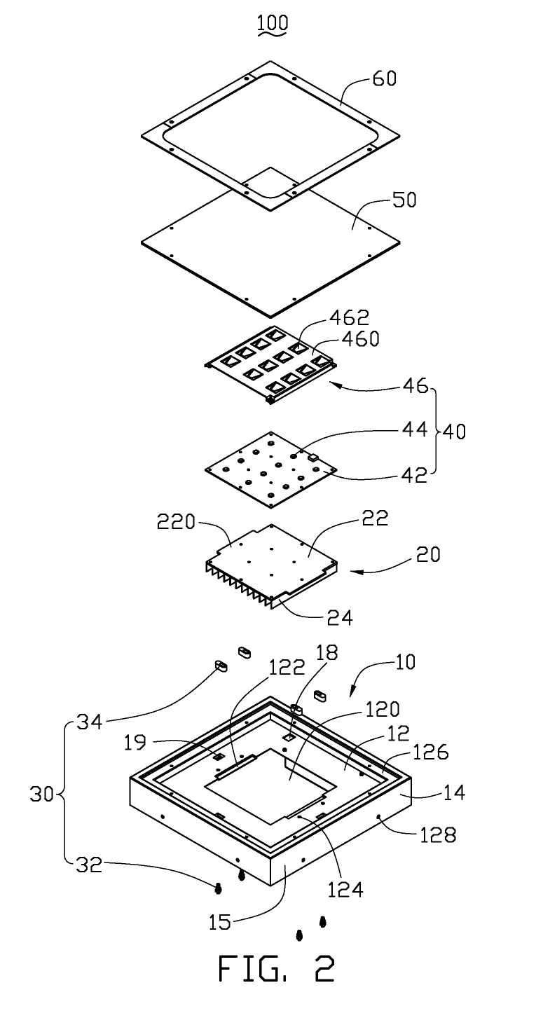

Referring to FIGS. 1-2, a light emitting module 100 is illustrated in accordance with an embodiment of the disclosure. The light emitting module 100 comprises a grille 10, a heat sink 20, a plurality of fasteners 30 securing the heat sink 20 into a center of the grille 10, an LED module 40 attached to an upper side of the heat sink 20, a transparent plate 50 mounted on a top end of the grille 10 and covering the heat sink 20 and the LED module 40, and an annular pressing portion 60 pressing a peripheral portion of the transparent plate 50 for mounting the transparent plate 50 on the grille 10.

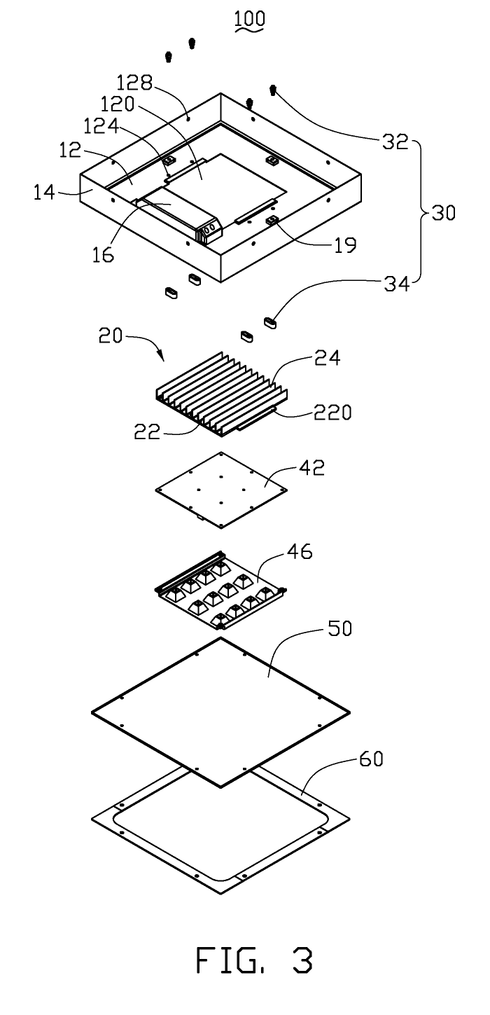

Referring also to FIG. 3, the shape of the grille 10 is not limited rectangular as shown in this embodiment. The grille 10 can also be triangular, round or other suitable shapes. The grille 10 comprises a plane, flat inner wall 12 and four sidewalls 14 extending upwardly and downwardly from outer edges of the inner wall 12. The sidewalls 14 cooperatively form a rectangular frame 15. The inner wall 12 is perpendicular to the sidewalls 14. A large, rectangular opening 120 is defined in a center of the inner wall 12. The inner wall 12 forms two spaced, confronting supporting portions 122 at two spaced, confronting sides of the opening 120 thereof. A plurality of through holes 124 are defined in the inner wall 12 near the supporting portions 122 for extension of the fasteners 30 therethrough. The supporting portions 122 are recessed downwardly relative to the inner wall 12 for supporting the heat sink 20. A flange 126 extends perpendicularly and inwardly from a top portion of the frame 15 so as to support the transparent plate 50, and a plurality of extending holes 128 are defined in a bottom portion of the frame 15. A power box 16 is mounted on a bottom face of the inner wall 12 for supplying electric energy to the LED module 40. A small, rectangular wire hole 18 is formed beside the power box 16 for guiding wires extending therethrough. The wires electrically connect the LED module 40 with the power box 16 for transmitting electric energy from the power box 16 to the LED module 40. A plurality of mounting portions 19 are disposed on the inner wall 12 and close to the frame 15 for mounting the grille 10 on a place such as a ceiling or a wall.

The heat sink 20 is integrally formed by metallic materials having a good thermal conductivity, such as copper, aluminum or alloy of copper and aluminum. The heat sink 20 comprises a rectangular, flat base 22 and a plurality of spaced parallel fins 24 extending perpendicularly and downwardly from the base 22. Two protrusions 220 protrude horizontally and outwardly from two opposite sides of the base 22, respectively. The protrusions 220 abut the supporting portions 122 of the inner wall 12 of the grille 10 respectively, and the fins 24 extend through the opening 120 of the inner wall 12 of the grille 10.

The LED module 40 is substantially rectangular in shape. The LED module 40 comprises a printed circuit board 42, a plurality of LEDs 44 attached to the printed circuit board 42 and a reflector 46 on the printed circuit board 42. The printed circuit board 42 is attached to the upper side of the heat sink 20. The reflector 46 has a shell-shaped configuration. The reflector 46 comprises a top wall 460 and a plurality of funnels 462 recessed downwardly relative to the top wall 460. The LEDs 44 are corresponding to the funnels 462 and extend through bottom portions of the funnels 462, thereby the LEDs 44 being received in corresponding funnels 462; accordingly, light emitted from the LEDs 44 is reflected by the reflector 46.

The transparent plate 50 is flat and made of transparent materials such as plastic, glass, or other suitable materials availing to transmit light. The peripheral portion of the transparent plate 50 abuts the flange 126 of the grille 10. A plurality of fasteners (not shown) extend through the pressing portion 60 and the transparent plate 50 in sequence and secure them to the flange 126. The transparent plate 50 is sandwiched between the pressing portion 60 and the flange 126.

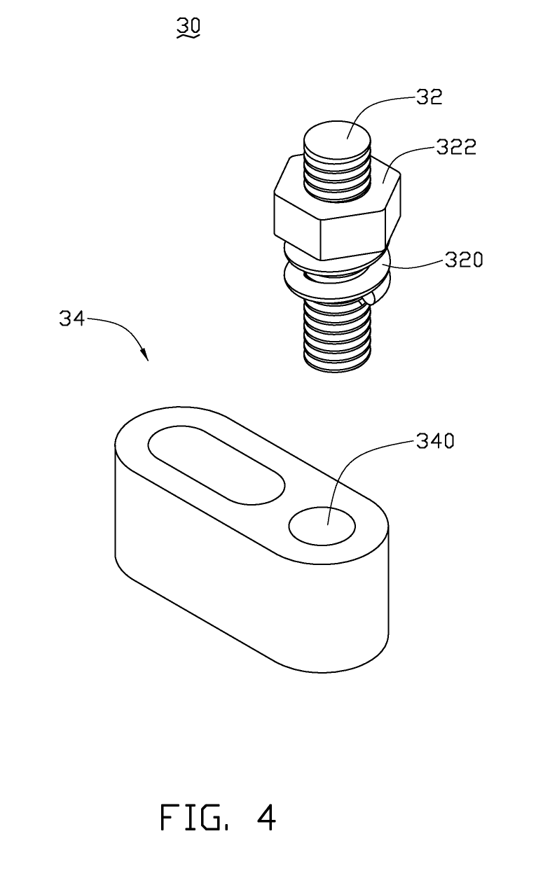

Referring also to FIG. 4, each fastener 30 comprises a threaded shaft 32, an elastic member 320 coiled around the shaft 32, a nut 322 screwed with an end of the shaft 32 and a resisting portion 34 screwed with an opposite end of the shaft 32. The elastic member 320 is located between the nut 322 and the resisting portion 34. The resisting portion 34 is an elliptic cylinder. The resisting portion 34 has an end defining a threaded hole 340 into which the opposite end of the shaft 32 is screwed. The shaft 32 extends upwardly through a corresponding through hole 124 near the supporting portions 122 of the grille 10. The elastic member 320 and the nut 322 are under the inner wall 12 of the grille 10, and the resisting portion 34 is above the inner wall 12. The resisting portion 34 can be rotated relative to shaft 32 and accordingly the corresponding through hole 124. In this embodiment, the elastic member 320 is a spring.

In assembly of the light emitting module 100, the shaft 32 of each fastener 30 extends upwardly through the corresponding through hole 124 of the inner wall 12 of the grille 10. The elastic member 320 is coiled around the shaft 32 and under the inner wall 12. The nut 322 is screwed with a bottom end of the shaft 32. The elastic member 320 is sandwiched and compressed between the nut 322 and the inner wall 12. The end of the resisting portion 34 defining the threaded hole 340 is screwed with a top end of the shaft 32, whereby each fastener 30 is assembled to the grille 10.

The resisting portion 34 of each fastener 30 is rotated relative to the corresponding through hole 124 at a position that another end thereof distant from the threaded hole 340 is away from a corresponding supporting portion 122 for allowing a corresponding protrusion 220 of the heat sink 20 to abut a corresponding supporting portion 122. The fins 24 of the heat sink 20 extend downwardly through the opening 120 of the inner wall 12 of the grille 10. Then, the resisting portion 34 is rotated relative to the corresponding through hole 124 to a position that the another end thereof is over the corresponding protrusion 220. The elastic member 320 of each fastener 30 is compressed between the nut 322 and the inner wall 12. Under a spring force of the elastic member 320, the another end of the resisting portion 34 tightly presses the corresponding protrusion 220, whereby the heat sink 20 is mounted on the grille 10. The LED module 40 is secured to the upper side of the heat sink 20. The transparent plate 50 and the pressing portion 60 are seated on the flange 126 of the grille 10 in sequence. The power box 16 is mounted on the bottom face of the inner wall 12 and electrically connected with the LED module 40 via the wires. In disassembly, the resisting portion 34 of each fastener 30 is rotated to be away from the corresponding supporting portion 122 and accordingly away from the corresponding protrusion 220 of the heat sink 20 for taking the heat sink 20 away from the grille 10. Thus, the heat sink 20 is conveniently installed to the grille 10 or removed from the grille 1 0.

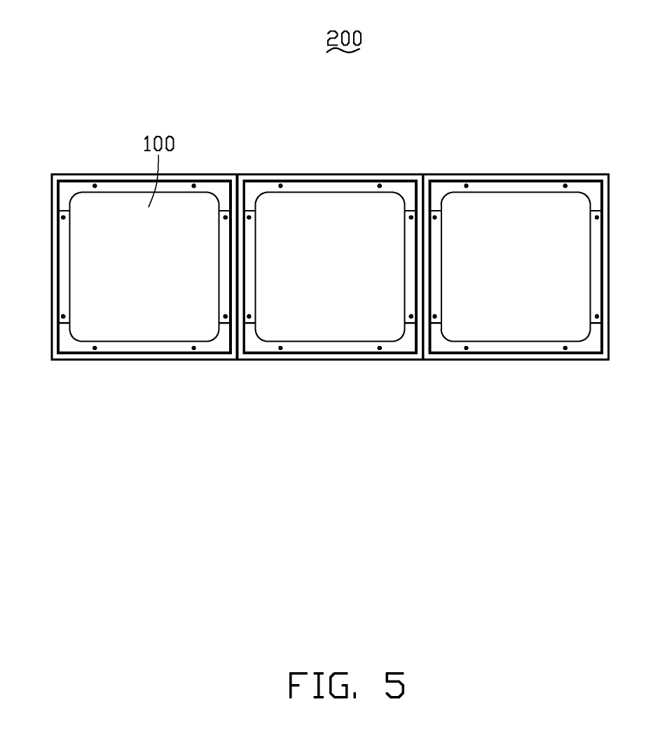

Referring to FIG. 5, an LED lamp 200 employing the light emitting module 100 is illustrated. The LED lamp 200 comprises a plurality of the light emitting modules 100 arranged in a row. Two corresponding sidewalls 14 of two adjacent light emitting modules 100 engage together by extending a plurality of screws (not shown) through the extending holes 128 of the corresponding sidewalls 14 for arranging the light emitting modules 100 together as a whole. In this illustrated embodiment, the LED lamp 200 has three light emitting modules 100 arranged in a row.

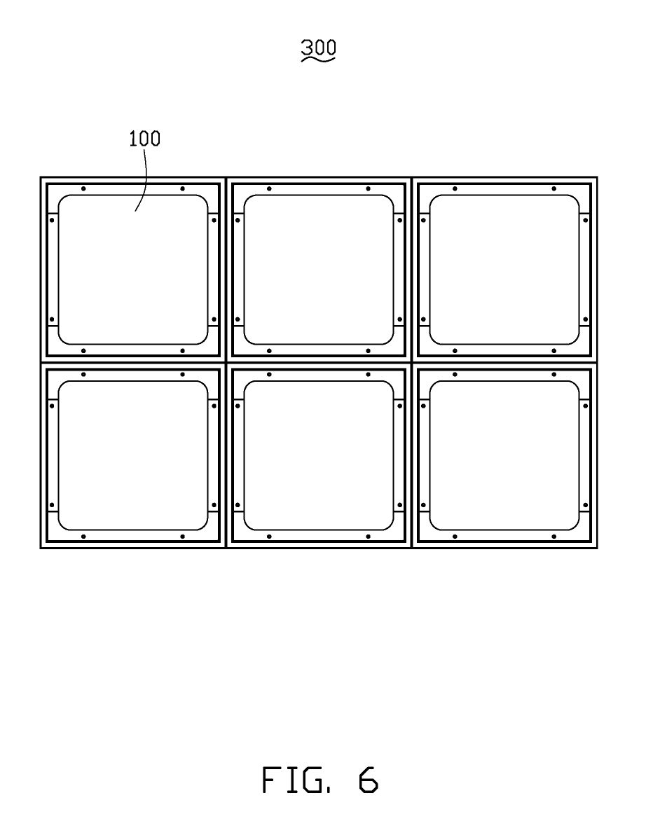

Referring to FIG. 6, an alternative LED lamp 300 employing the light emitting module 100 is illustrated. The LED lamp 300 is similar to the LED lamp 200 of the first embodiment. The LED lamp 300 comprises a plurality of the light emitting modules 100 arranged in many rows and in many columns. The number of the light emitting module 100 in each row and the number of the light emitting module 100 in each column can be arranged according to an actual need. In this illustrated embodiment, the LED lamp 300 has six light emitting modules 100 arranged in two rows and in three columns.

According to the present disclosure, on one hand, it is convenient to assemble or disassemble an LED lamp having many light emitting modules 100 arranged in many rows and in many columns by assembling or disassembling the screws to or away from the corresponding sidewalls 14 of the adjacent light emitting modules 100. On the other hand, the numbers of the light emitting module 100 in each row and in each column can be arranged according to actual needs for achieving different illumination intensities. In addition, the LED lamp of the disclosure can replace a grille lamp utilizing fluorescent lights as a source of illumination.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A light emitting module comprising:
a grille comprising an inner wall and a frame extending integrally upwards and downwards from outer edges of the inner wall;
a heat sink having a bottom portion thereof extending through the inner wall and having two opposite ends of a top portion thereof abutted against the inner wall;
an LED module attached to a top side of the heat sink; and
a plurality of fasteners pivotally engaging with the inner wall of the grille and near the heat sink, each of the fasteners comprising a resisting portion abutting the top portion of the heat sink, thereby abutting the heat sink on the inner wall.

2. The light emitting module as claimed in claim 1, wherein the fasteners each further comprise a shaft extending through the inner wall, the resisting portion abutting a corresponding end of the top portion of the heat sink and being screwed with a top end of the shaft.

3. The light emitting module as claimed in claim 2, wherein the resisting portion is an elliptic cylinder, the resisting portion having an end defining a threaded hole into which the top end of the shaft is screwed and having an opposite end abutting the corresponding end of the top portion of the heat sink and being rotatable relative to the shaft.

4. The light emitting module as claimed in claim 3, wherein the fasteners each further comprise an elastic member coiled around the shaft and a nut screwed with a bottom end of the shaft, the elastic member being compressed between the nut and the inner wall of the grille, thereby making the opposite end of the resisting portion abut tightly the corresponding end of the top portion of the heat sink.

5. The light emitting module as claimed in claim 1, wherein the inner wall of the grille has an opening defined in a center thereof, the inner wall forming two spaced, confronting supporting portions at two spaced, confronting sides of the opening.

6. The light emitting module as claimed in claim 5, wherein the supporting portions of the inner wall of the grille are recessed downwardly relative to the inner wall for supporting the opposite ends of the top portion of the heat sink.

7. The light emitting module as claimed in claim 6, wherein the top portion of the heat sink comprises a base and two protrusions outwardly from two opposite ends of the base, the protrusions abutting the supporting portions of the inner wall of the grille, the opposite end of the resisting portion of the fastener abutting a corresponding protrusion.

8. The light emitting module as claimed in claim 1 further comprising a transparent plate, wherein the frame of the grille is perpendicular to the inner wall, a flange extending inwardly and horizontally from a top end of the frame for supporting the transparent plate.

9. An LED lamp comprising:
an array of light emitting modules, the light emitting modules each comprising:
a grille comprising an inner wall and a frame extending integrally upwards and downwards from the inner wall;
a heat sink having a bottom portion thereof extending through the inner wall and having two opposite ends of a top portion thereof abutted against the inner wall;
an LED module attached to a top side of the heat sink; and
a transparent plate mounted on a top end of the grille and covering the heat sink and the LED module.

10. The LED lamp as claimed in claim 9, wherein the frames of two adjacent ones of light emitting modules are connected together.

11. The LED lamp as claimed in claim 9, wherein each of the light emitting modules further comprises a plurality of fasteners for mounting the heat sink on the inner wall of the grille, and wherein the fasteners each comprise a shaft and a resisting portion screwed with a top end of the shaft, the shafts extending through the inner wall, the resisting portions abutting the opposite ends of the top portion of the heat sink, thereby abutting the heat sink on the inner wall.

12. The LED lamp as claimed in claim 11, wherein the resisting portion of each fastener is an elliptic cylinder, the resisting portion having an end defining a threaded hole into which the top end of the shaft is screwed and having an opposite end abutting a corresponding end of the top portion of the heat sink and being rotatable relative to the shaft.

13. The LED lamp as claimed in claim 12, wherein the fasteners each further comprise an elastic member coiled around the shaft and a nut screwed with a bottom end of the shaft, the elastic member being compressed between the nut and the inner wall of the grille, thereby making the opposite end of the resisting portion abut tightly against the corresponding end of the top portion of the heat sink.

14. The LED lamp as claimed in claim 12, wherein the inner wall of the grille of each of the light emitting modules has an opening defined in a center thereof, the inner wall forming two spaced, confronting supporting portions at two spaced, confronting sides of the opening.

15. The LED lamp as claimed in claim 14, wherein the supporting portions of the inner wall of the grille are recessed downwardly relative to the inner wall for supporting the opposite ends of the top portion of the heat sink.

16. The LED lamp as claimed in claim 15, wherein the top portion of the heat sink comprises a base and two protrusions extending outwardly from two opposite ends of the base, the protrusions abutting the supporting portions of the inner wall of the grille, the opposite end of the resisting portion of the fastener abutting a corresponding protrusion.
